(19) United States
(12) Patent Application Publication
(10) Pub. No.: US 2007/0289825 A1
(43) Pub. Date: Dec. 20, 2007

(54) Cam-operated release cable for brake actuator

(75) Inventors: Simon Chan, Markham (CA); Peter Revelis, Newmarket (CA)

Correspondence Address: PILLSBURY WINTHROP SHAW PITTMAN, LLP, P.O. BOX 10500, MCLEAN, VA, 22102, US

(73) Assignee: Ventra Group Inc., Bradford (CA)

(21) Appl. No.: 11/452,394

(22) Filed: Jun. 14, 2006

(51) Int. Cl. F16D 65/14

(52) U.S. Cl. 188/2 D

(57) ABSTRACT

The present invention provides for a brake actuator for use in a motor vehicle. In a motor vehicle with one or more brakes activated by a cable system, there is a lever, a pawl resiliently biased to engage a sector, and a cam member. Connected to the cam member is a cable that can tension and release the pawl by movement of a button that is slidably engaged with the cam member.

### FIELD OF THE INVENTION

The present invention relates to a cam operated hand-brake release.

### BACKGROUND OF THE INVENTION

Parking brake actuators on motor vehicles are usually either hand-operated or foot-operated. For hand-operated actuators, the device contains a mounting bracket affixed to the interior floor of a motor vehicle. An actuator lever is rotatably attached to the mounting bracket, allowing the actuator lever to be moved upward from a released position to an engaged position. Typically, a take-up reel, often referred to as a cam, is attached to the actuator lever. This cam translates the upward motion of the actuator lever into horizontal motion of, and increased tension in, the cable. This in turn, activates the parking brakes of the motor vehicle.

Typically, the actuator lever will remain in the engaged position (i.e., raised) due to the ratcheting action of a pawl and sector. The actuator lever can be moved from the engaged position to the released position (i.e., lowered) by disengaging the pawl from the sector, thereby releasing the cable tension that activates the parking brake of the motor vehicle. The disengaging of the pawl is usually the result of movement of a tie rod that connects the pawl and the release button. Typically, the release button is depressed against a spring bias, resulting in motion of the tie rod. However, because a pushing motion of the tie rod is required to disengage the pawl from the sector, the actuator lever in which the tie rod is housed typically must be substantially linear to accommodate the linear motion of the tie rod. Thus, the shape of the motor vehicle console is often limited so as to accommodate the straight actuator lever.

### SUMMARY OF THE INVENTION

The present invention provides a brake actuator for use in a motor vehicle having one or more cable-actuated vehicle brakes. The brake actuator contains a mounting bracket, and a lever with a handgrip portion for movement in applying and releasing directions. The lever has a lever position retainer that can be moved between a first position preventing movement of the lever in the releasing direction and a second position allowing movement of the lever. Mounted on the handgrip portion of the lever is a depressible element with a camming surface that is engageable with a cam member that is movably mounted to the lever and which can cam against and move cam member. In addition, there is a cable that extends within the lever and connects the cam member to the lever position retainer and that allows the movement of the cam member to move the lever position retainer and engage or release the vehicle brakes

Other objects, features, and advantages of the present invention will be appreciated from the following detailed description, the accompanying drawings, and the appended claims.

### BRIEF DESCRIPTION OF THE DRAWINGS

FIG. 1 is a side profile of the brake actuator and a cut-away view of the lever and the cam mechanism of the brake actuator;

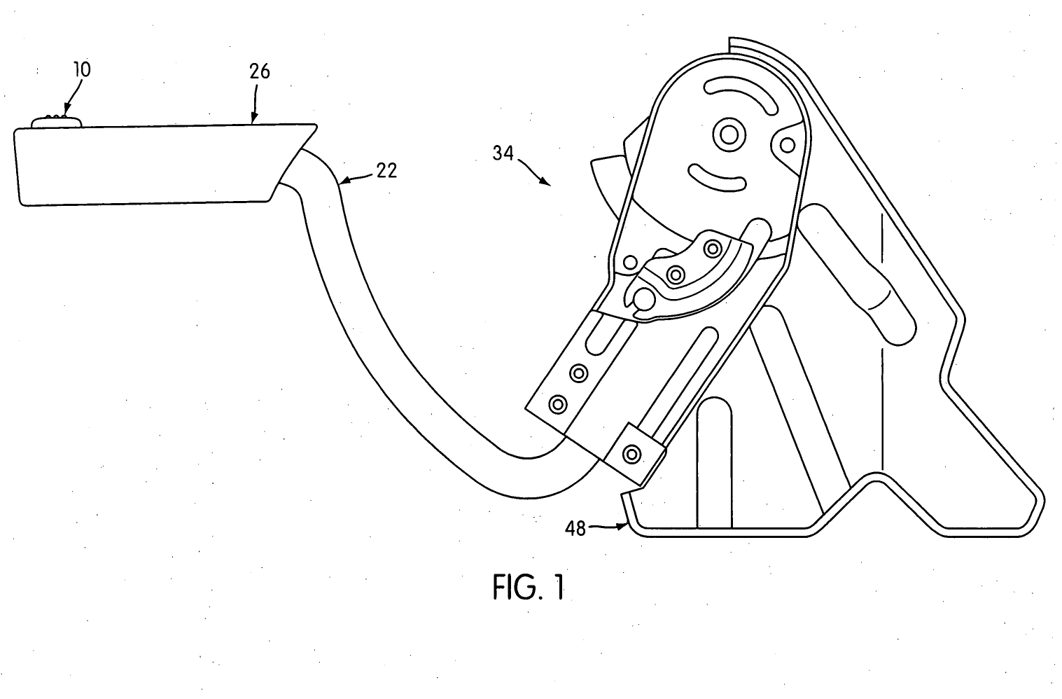

FIG. 2 is an cut-away view of the lever and the cam mechanism of the brake actuator of FIG. 1;

FIG. 3 is an cut-away view of the lever and the cam mechanism of the brake actuator of FIG. 1

FIG. 4 is an cut-away view of the lever and the ratcheting mechanism of the brake actuator of FIG. 1; and

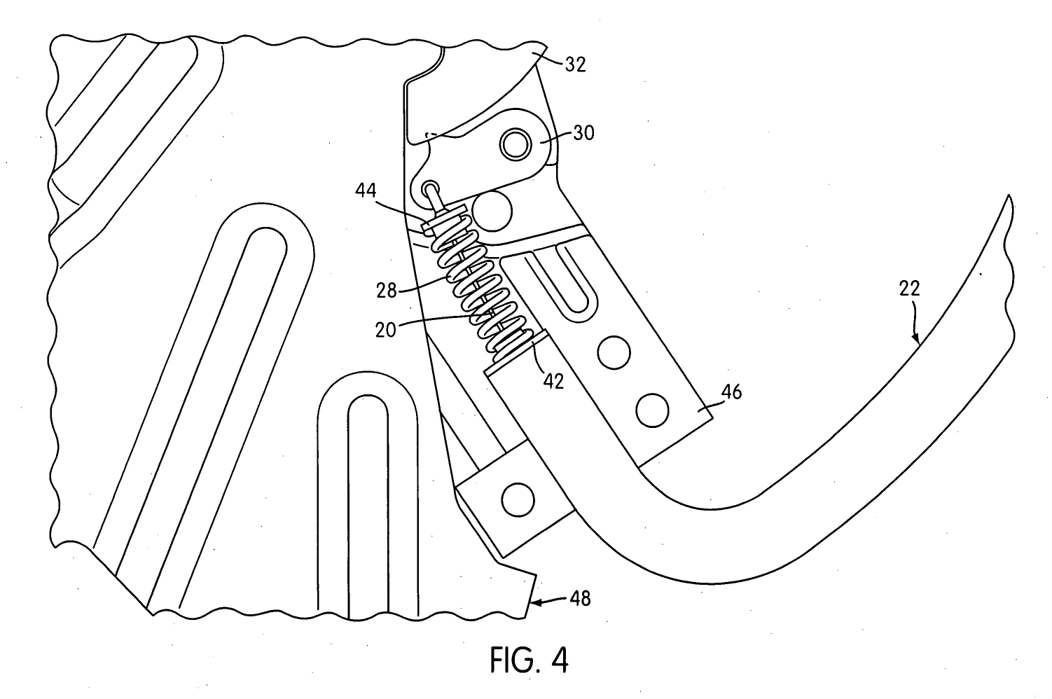

FIG. 5 is a schematic illustration of a motor vehicle containing the brake actuator of FIG. 1.

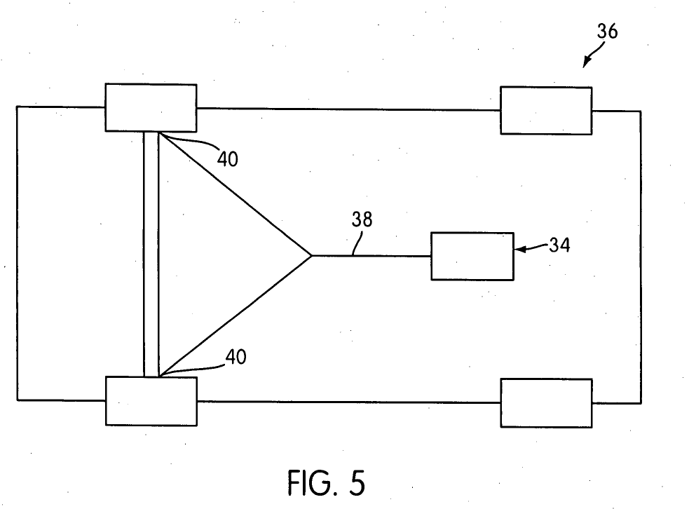

### DETAILED DESCRIPTION OF ILLUSTRATED EMBODIMENT OF THE INVENTION

The Figures illustrate a brake actuator 34 for use in a motor vehicle 36. The brake actuator 34 engages or actuates the brakes 40 of the motor vehicle by tensioning brake cables 38. The brake cables 38 are tensioned by movement of the actuator lever 22 of the brake actuator 34 in the engaging direction by lifting or pulling up on the actuator lever 22. The brake cables 38 are released by movement of the actuator lever 22 in a releasing direction by pushing down upon the actuator lever 22. When the actuator lever 22 is moved in the brake engaging direction, the brake cables 38 are tensioned and the brakes 40 are applied to prevent rolling movement of the vehicle.

The brake actuator 34 will be mounted to the floor of the motor vehicle 36 by the mounting bracket 48. The mounting bracket 48 may be made of any number of materials, including metal, plastic, rigid rubber, or composite or compound materials. Pivotally attached to the mounting bracket is actuator lever 22. At one end of the actuator lever 22 is a handgrip 26 that is designed to allow for the convenient and comfortable gripping of the actuator lever 22 by a user. As an option, the handgrip may be covered by a soft or rigid plastic or foam for enhanced comfort.

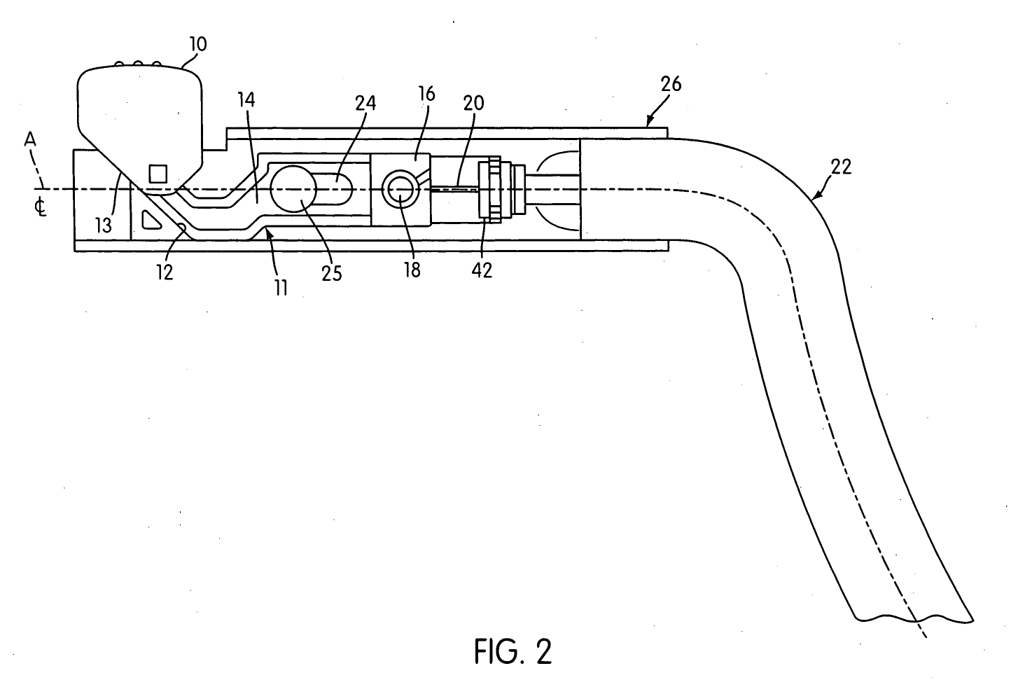

At one end of actuator lever 22 is the cam member 11 (FIG. 2.). The cam member 11 includes ramp 12, guide slot 24, cable receiving member 16, and cam body 14. Also disposed at the same end of the actuator lever 22 is a depressible element; shown by way of example as a button 10. The handgrip 26 encloses the cam member 11 and the end of the actuator lever 22. In one embodiment, the button 10 is slidably engaged with the ramp 12. The button 10 can be depressed by a user in the vertical direction (as shown in FIG. 2, which is the generally radial direction of the lever's longitudinal axis A). Preferably, the button 10 is restrained so as to be generally incapable of substantial movement in horizontal directions. Conversely, the cam member 11 and the ramp 12 are capable of movement in the horizontal direction, but are generally incapable of substantial movement in vertical directions.

When the button 10 is depressed, it causes an angled camming surface to cam against the ramp 12 and the cam member 11 is moved in a cable tensioning direction. Thus, the vertical movement of the button 10 is translated into horizontal movement of the cam member 11 by way of the ramp 12. The camming surface of the button 10 is in contact with the camming surface of the ramp 12, and these two surfaces slide against each other in opposite directions as the button 10 is depressed and as the camming surface of the button 10 exerts a force upon the camming surface of the ramp 12. The camming surfaces of the button 10 and the ramp 12 slide against each other in both horizontal and vertical directions, which allows the vertical movement of the button 10 to translate into horizontal movement of the ramp 12 and the cam member 11. When the user releases the button 10, the camming surfaces of the button 10 and the ramp 12 slide against each other again, such that the camming surface 13 of the ramp 12 exerts a force upon the camming surface of the button 10 and causes the button 10 to move in an opposite direction from the direction in which the button 10 was depressed. Preferably, the button 10 and ramp 12 are constructed of suitable materials that allow their respective camming surfaces to slide against one another with minimal friction.

Although the Figures depict the button 10 as mounted upon the top of the handgrip 26, the invention is not so limited. Indeed, the button 10 may be mounted on the bottom of the handgrip 26, or on any side of the handgrip 26. By changing the orientation of the cam member 11 to match the orientation of the button 10, any possible orientation of the button will achieve the desired result. Moreover, the button 10 need not appear exactly as depicted in the figures. Instead, the button may be part of an integral molded piece of plastic or other suitable material that is joined with the handgrip 26. For example, the button 10 may take the form of a lever or a rocker that is pivotally mounted to the handgrip 26 such that the user may depress the lever or rocker and, in so doing, cause the cam member 11 to move in a cable tensioning direction.

In addition to the button 10 camming against a ramp 12, the button 10 may also be disposed such that it may be depressed in a horizontal or non-orthogonal direction relative to the longitudinal axis of the handgrip 26 of the actuator lever 22. The button 10 may be engaged with the cam member 11 such that movement of the cam member 11 in a first direction that tensions the cable 20 is caused by the depression of the button 10 in a second direction that is opposite to the first direction. The actuator lever 22 and the handgrip 26 may thus appear to have the conventional arrangement wherein the button 10 is disposed on the end of the actuator lever 22. The engagement mechanism that allows for the motion of the button 10 in a second direction to translate into motion of the cam member 11 in a first direction may be a cantilever, a rotating cam, or any suitable structure for translating force in a first direction into force in a second, opposite direction.

Disposed in cam body 14 is a guide slot 24, which acts to limit the horizontal travel of the cam member 11. This is accomplished by a pin 25 that fits within the guide slot 24 and provides a stop in either direction for the horizontal travel of the cam member 11. Also disposed on the cam body 14 is a cable receiving member 16, which is designed to receive cable end 18. The design of cable receiving member 16 is such that it allows the cable 20 to be removably or fixedly attached to the cam member 11, thereby providing greater ease of manufacture. On one end, the cable 20 is attached to cable end 18, and on the other end the cable 20 is attached to a pawl 30.

The cable 20 travels from the point at which it is attached to the cam member 11 through the actuator lever 22 to a point at which it is attached to a pawl 30. The pawl 30 is movably mounted to the actuator lever 22 and is designed to engage the teeth of a sector 32 such that when so engaged, the pawl 30 prevents movement of the actuator lever. The sector 32 is mounted to the mounting bracket 48. Such ratcheting pawls and sectors are well known in the art. The pawl 30 is biased against the sector 32 by spring 28, which is engaged between spring stops 42 and 44. Thus, when the actuator lever 22 is in a brake applying position and the pawl 30 is in its normal position engaging the sector 32, the actuator lever 22 cannot move in a brake releasing direction without operating the button 10 to move the pawl 30 to a disengaged position wherein it is disengaged from the sector 32.

In a typical brake actuator, the pawl 30 is moved by the lateral movement of a tie rod. Because tie rods are rigid and straight, they cannot be housed within an actuator lever 22 that has a significant or severe bend. A flexible cable 20 is the best option when, for example, the actuator lever 22 is “S” shaped or has some other tortuous configuration with one or more bends. By using cable 20 to disengage the pawl 30 from the sector 32 by tensioning the cable, a user can enjoy the befits of a severely curved actuator lever 22 without any loss in performance or function. Indeed, due to the flexibility of the cable 20, the actuator lever 22 does not need to be limited to a “S” shape, as any suitable shape falls within the scope of the present invention, including but not limited to shapes that incorporate a 90 degree or greater bend or that bend in both horizontal and vertical directions. In addition, the present invention will also function in an actuator lever 22 that is substantially straight. By allowing the actuator lever 22 to bend in any number of directions, the actuator lever can take any shape necessary to accommodate the motor vehicle console.

In one embodiment, the cable 20 travels through the spring 28, although alternate configurations are contemplated where the cable 20 would not be housed within spring 28. Additionally, the spring 28 need not be a coil type spring, as any type of spring could provide the required biasing force. The first spring stop 42 is rigidly affixed to the lever plate 46, whereas the second spring stop 44 is rigidly affixed to the cable 20.

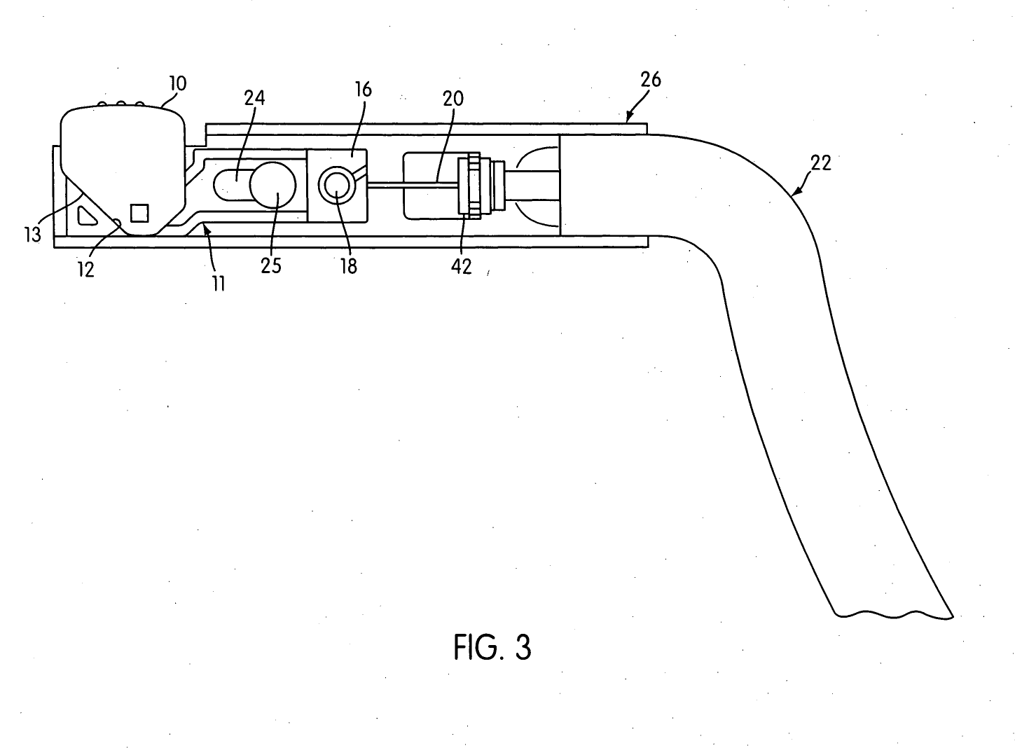

FIG. 2 shows the cam member 11 and the button 10 in an undepressed position. When the button 10 is depressed and the cam member 11 travels in the horizontal plane, the cable 20 is tensioned. FIG. 3 shows the button 10 and the cam member 11 after a user depresses the button 10. When the cable 20 is tensioned, spring 28 is compressed and the pawl 30 is pulled by the cable 20 against the spring bias to be disengaged from the teeth of the sector 32. This allows the actuator lever 22 to travel from the engaged position to the released position. Once the button 10 is released, the spring 28 will bias the pawl 20 back into contact with the sector 32, thereby preventing movement of the actuator lever 22.

The cam member 11 may be made of any number of suitable materials, including plastic, metal, composite materials or any combination thereof. Similarly, the button 10 may also be made from plastic, metal, composite materials or any combination thereof. Ideally, the surface of the button 10 that slidably engages the ramp 12 of the cam member 11 will be sufficiently smooth such that the friction between the two surfaces does not make tensioning the cable 20 unduly difficult.

Because the cable 20 takes a tortuous path through the actuator lever, there is disposed within the actuator lever 22 a sleeve 42. The cable 20 is disposed within the sleeve 42. The ends of sleeve 42 are affixed at both ends such that the cable 20 and the sleeve 42 may take any path through the actuator lever 22 while ensuring that the movement of the cable 20 at one end translates into equal movement of the cable 20 at its other end. When a force is applied to the cable 20, the cable 20 moves relative to the sleeve 42 to translate the force. The cable 20 has an exterior diameter that closely matches or exactly matches the internal diameter of the sleeve's passage. This design, often referred to as a Bowden cable, is advantageous because it allows flexibility in the installation of the sleeve/cable assembly, and avoids the need for forming a conduit with close tolerances in the lever itself.

In other embodiments, the pawl 30 and sector 32 may be replaced with another device for retaining the lever position. For example, a one-way spring clutch may serve to retain the lever in a brake applying position against movement in the releasing direction (but allow further movement in the brake applying direction). The cable 20 may be connected to a tang of the spring clutch and pulling the cable 20 may open the clutch to allow movement of the lever in either the applying or releasing directions The natural resiliency of the spring clutch will bias it back to its normal clutched position. Such devices for retaining the lever in a brake applying position may be generically referred to as a lever position retainer.

The foregoing illustrated embodiment has been provided solely for the purpose of illustrating the structural and functional principles of the present invention, and it is not intended to be limiting. To the contrary, the present invention is intended to encompass all variables, modifications, alterations, substitutions, and equivalents within the spirit and scope of the following claims.

What is claimed:

1. A brake actuator for use in a motor vehicle having one or more vehicle brakes actuable by a cable system comprising one or more cables, comprising:
a mounting bracket;
a lever provided on the mounting bracket for movement in applying and releasing directions, the lever having a handgrip portion;
a lever position retainer movable between (a) a first position preventing movement of the lever in the releasing direction from a brake applying position, and (b) a second position allowing movement of the lever in both the applying and releasing directions, the lever position retainer being biased to the first position;
a depressible element mounted on the handgrip portion of the lever, the depressible element having a camming surface;
a cam member movably mounted to the lever adjacent the element and having a camming surface engageable by the camming surface of the button;
a cable extending within the lever and connecting the cam member to the lever position retainer such that movement of the cam member in a first direction pulls the cable to move the lever position retainer from the first position to the second position against the bias; and
the camming surfaces of the depressible element and the cam member being configured such that depressing the depressible element cams the camming surface to move the cam member in the first direction for pulling the cable.

2. The brake actuator of claim 1, wherein the depressible element is a button.

3. The brake actuator of claim 2, wherein the button is movable in a direction generally radial to a longitudinal axis of the lever.

4. The brake actuator of claim 2, wherein the cam member comprises a ramp that is slidably engaged with said button.

5. The brake actuator of claim 1, further comprising an actuator lever that has a bending and tortuous shape and a cable along a tortuous path within the lever.

6. The brake actuator of claim 1, wherein the lever position retainer comprises:
a pawl movably mounted to the lever;
a sector provided on the mounting bracket; and
a spring biasing the pawl into engagement with the sector to provide the first position of the lever position retainer,
wherein the cable is connected to the pawl such that movement of the cam member in the first direction pulls the cable to disengage the pawl from the sector to provide the second position of the lever position retainer.

7. The brake actuator of claim 6, wherein said cable extends through said spring.

8. The brake actuator of claim 7, wherein the spring is a coil spring.

9. The brake actuator of claim 8, further comprising first and second spring stops, the first spring stop being fixed on the lever and the second spring stop being mounted to the pawl, wherein the spring is mounted between the spring stops.

10. The brake actuator of claim 3, further comprising a sleeve houses the cable and which is fixed at both ends.

11. A motor vehicle comprising:
one or more vehicle brakes;
a cable system comprising one or more cables for actuating the one or more vehicle brakes; and
a mounting bracket;
a lever provided on the mounting bracket for movement in applying and releasing directions, the lever having a handgrip portion;
a lever position retainer movable between (a) a first position preventing movement of the lever in the releasing direction from a brake applying position, and (b) a second position allowing movement of the lever in both the applying and releasing directions, the lever position retainer being biased to the first position;
a depressible element mounted on the handgrip portion of the lever, the depressible element having a camming surface;
a cam member movably mounted to the lever adjacent the element and having a camming surface engageable by the camming surface of the button;
a cable extending within the lever and connecting the cam member to the lever position retainer such that movement of the cam member in a first direction pulls the cable to move the lever position retainer from the first position to the second position against the bias; and
the camming surfaces of the depressible element and the cam member being configured such that depressing the depressible element cams the camming surface to move the cam member in the first direction for pulling the cable.

12. The motor vehicle of claim 11, wherein the depressible element is a button.

13. The motor vehicle of claim 12, wherein the button is movable in a direction generally radial to a longitudinal axis of the lever.

14. The motor vehicle of claim 13, wherein the cam member comprises a ramp that is slidably engaged with a button.

15. The motor vehicle of claim 11, further comprising an actuator lever that has a bending and tortuous shape and a cable along a tortuous path within the lever.

16. The motor vehicle of claim 11, wherein the lever position retainer comprises:
a pawl movably mounted to the lever;
a sector provided on the mounting bracket; and
a spring biasing the pawl into engagement with the sector to provide the first position of the lever position retainer,
wherein the cable is connected to the pawl such that movement of the cam member in the first direction pulls the cable to disengage the pawl from the sector to provide the second position of the lever position retainer.

17. The motor vehicle of claim 16, wherein said cable extends through said spring.

18. The motor vehicle of claim 17, wherein the spring is a coil spring.

19. The motor vehicle of claim 18, further comprising first and second spring stops, the first spring stop being fixed on the lever and the second spring stop being mounted to the pawl, wherein the spring is mounted between the spring stops

20. The motor vehicle of claim 13, further comprising a sleeve houses the cable and which is fixed at both ends.
